(19) United States
(12) Patent Application Publication
(10) Pub. No.: US 2010/0309295 A1
(43) Pub. Date: Dec. 9, 2010

(54) 3D VIDEO PROCESSOR INTEGRATED WITH HEAD MOUNTED DISPLAY

(76) Inventor: Kenny W. Y. Chow, North Point (HK)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/794,044

(22) Filed: Jun. 4, 2010

Related U.S. Application Data
(60) Provisional application No. 61/184,088, filed on Jun. 4, 2009.
(60) Provisional application No. 61/237,879, filed on Aug. 28, 2009.

(51) Int. Cl. H04N 13/04; G09G 5/00

(52) U.S. Cl. 348/53; 345/8; 348/E13.075

(57) ABSTRACT

A 3-D stereo video device that includes a headset housing that incorporates a 3-D video processor chip, video display driver circuitry, micro-displays and optics such that the only required external component is a joystick or other user input device. By utilizing a direct digital video interface between the video processor chip and the video driver chip, the need for video signal encoder/decoders, digital to analog converters, video up-converters and other similar complicated circuitry to handle remotely generated analog video signals are eliminated. The design not only saves cost but also allows for a higher resolution, higher frame-rate video presentations than previous designs.

### RELATED APPLICATION(S)

This application claims the benefit of U.S. Provisional Application No. 61/184,088, filed on Jun. 4, 2009 and U.S. Provisional Application No. 61/237,879, filed on Aug. 28, 2009. The entire teachings of the above applications are incorporated herein by reference.

### BACKGROUND

Head-mounted displays have been known for quite some time. Certain types of these displays are worn like a pair of eyeglasses. They may have a display element for both the left and right eyes and this can provide computer generated stereo video images. They may be designed to present a smoked-plastic “sunglasses” look to the outside world. Products on the market today can provide a reasonably immersive viewing experience in a small, portable, compact form factor.

The optical imaging path for each eye typically consists of a Light Emitting Diode (LED) for backlight illumination, a polarizing film, and a micro-display Liquid Crystal Display (LCD) element in a molded plastic package. Among the pieces in the optical path, the micro-display element typically takes center stage. Suitably small color LCD panels are available from sources such as Kopin Corporation of Westboro, Mass. Kopin's displays such as the CyberDisplay® models can provide QVGA, VGA, SVGA and even higher resolution depending on the desired quality of the resulting video.

Head-mounted displays are sometimes used in products such as electronic games. For example, a game known as i-Combat™ from a company called Radica Games and a product such as the Virtual Boy™ from Nintendo date from the mid-1990's time-frame. These games used low quality displays of varying types implemented, for example, with Light Emitting Diode (LED) technology and an oscillating mirror system to present the image. These devices also had various types of connected controllers and game cartridge interfaces.

### SUMMARY OF THE DISCLOSURE

What is needed is a high quality, high frame rate, high resolution, small, portable platform for providing a 3-D stereo full video experience at low cost.

In a preferred embodiment, a 3-D stereo video device includes a headset housing that incorporates a 3-D video processor chip and display driver circuitry, micro-displays and optics. By utilizing a direct digital video interface between the video processor chip and the video driver chip, the need for video signal encoder/decoders, digital to analog converters, video up-converters and other similar complicated circuitry to handle remotely generated analog video signals is eliminated.

The 3-D video processor chip may include a video game processor that contains 3-D processing hardware and/or firmware to execute 3-D graphics generating game program software. The game processor may interact with a user joystick or other game controller, ideally through a wireless interface, to complete game playing action. Through the digital video interface, the game processor preferably outputs a stereoscopic image pair (left and right) at a stable video rate.

The design not only saves cost but also allows for a higher resolution, higher frame-rate video presentation, and lower power consumption.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments.

FIG. 1 is an external perspective view of a 3-D head-mounted video display unit.

FIG. 2 is a block diagram of the electronic components of the unit.

FIG. 3 is a more detailed block diagram of the display controller.

FIG. 4 is a pin out diagram of a preferred 3D video processor chip that may include a game processor.

### DETAILED DESCRIPTION

A description of example embodiments follows.

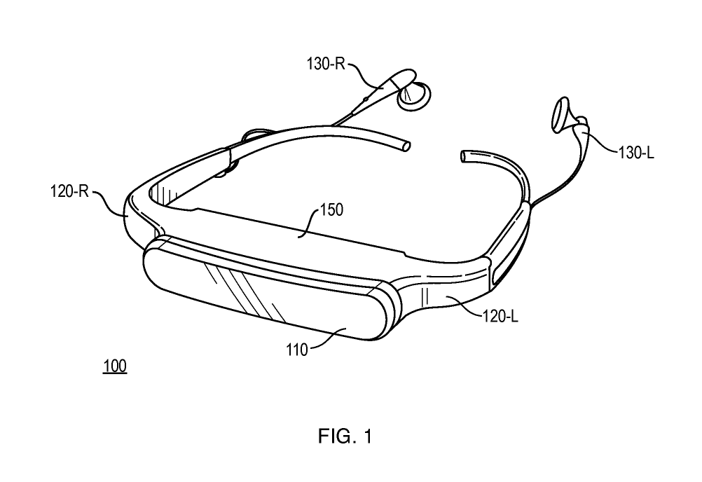

FIG. 1 is a perspective view of a 3-D video device implemented with a head-mounted display (HMD) 100 which may incorporate preferred embodiments of the invention. As illustrated, the HMD 100 is implemented, similar to a pair of eyeglasses, in a housing 150. The housing 150 includes an eyepiece 110 with dual micro-displays, one for each of a left 120-L and right 120-R side. The housing 150 also includes a video chip, such as but not limited to, a video processor, a display controller, and other circuitry needed to implement a high resolution 3-D video application such as a video game, as described in more detail below. The device 100 may also include one or more ear buds 130-L, 130-R for providing audio. The housing 150 may be fabricated from molded plastic or other suitable materials.

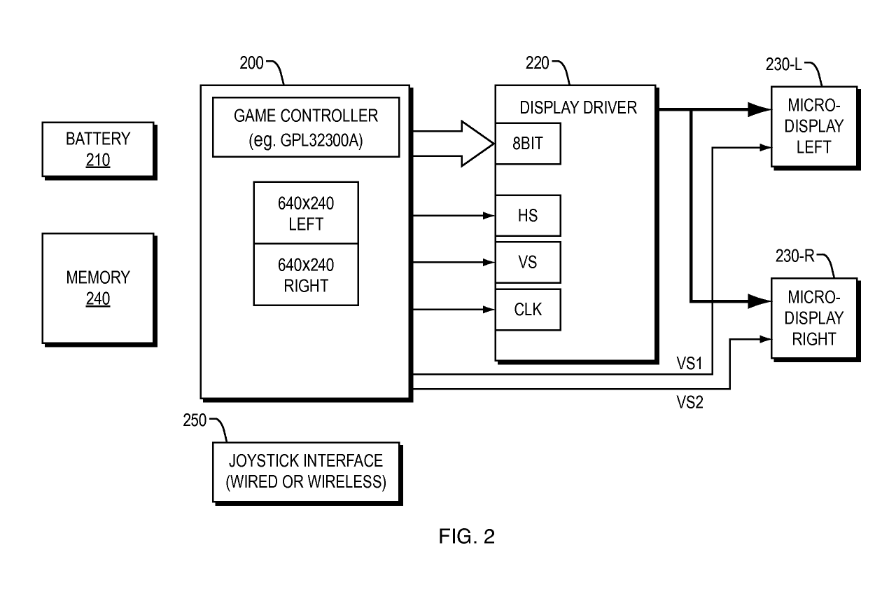

FIG. 2 is a high level block diagram of the electronic components of the video device 100. It includes at least a video processor chip 200, display driver 210, the left 230-L and right 230-R micro-displays, and a power source such as a battery 210. A removable memory 240 and a joystick (or other user input device or controller) interface 250 are optional but preferable. All of the components of FIG. 2 are included within the housing 150 of the device 100 in a preferred embodiment.

The 3-D video processor chip 200 may be a video game integrated circuit from General Plus known as the GPL 32300 A. The display driver 220 may, for example, be the Kopin A220/A221 Display Driver KCD-A220-BA or KCD-A221-BA. The left and right micro-displays 230 may for example be a Kopin CyberDisplay micro-display.

The joystick interface 250 may be any suitable interface that connects to an external user input device by either a wired or wireless (i.e. Bluetooth or infrared) interface.

The 3-D video processor chip 200 outputs both left and right full-frame digital video signal via a parallel output bus interface. The outputs are preferably compatible with the International Telecommunication Unit (ITU) interface for digital component video signals, such as, specifically Recommendation BT.656. Thus, for example, the GPL 32300A game processor chip 200 outputs full frame rate digital video as a pair of 8-bit wide, BT.656-compatible, left and right video channel signals.

BT.656 is a digital video protocol for streaming uncompressed PAL or NTSE standard definition television signals of either 525 or 625 lines. As is known, the BT.656 protocol utilizes the digital video encoding parameters defined in ITU-R BT.601 providing for interlaced video data, streaming each field separately, and using a YCbCr color space at a 13.5 MegaHertz (MHz) pixel sampling rate. In a preferred embodiment, a parallel 8-bit BT.656 interface is used although it is possible that higher resolution, i.e., 10-bit interfaces can also be provided. In a preferred embodiment, the video processor chip 200 provides at least a 640 by 240 resolution, that is, 320 by 240 for each of the left and right channel signals.

The software on the video processor chip 200 can also preferably generate both the left and right images to implement 3-D stereoscopic image effects in the resulting video signals. More particularly, the video processor 200 is programmed to output left and right image frames alternately to drive the left and right displays 230 through the display driver 220 at frame rate which matches the response time of the displays 230, to eliminate the effect of flickering.

If the video chip is a GPL 32300A game processor chip 200, it also includes other functions such as a game software processor to execute a game program stored in internal or external memory 240. Memory 240 may be provided by read only or flash memory devices as external proprietary game cartridges, Compact Flash, Secure Digital, xD, Memory Stick, or other compatible memory devices.

The immediately adjacent display driver circuit 220 accepts the two BT.656 video signals from the game processor chip 200 and generates left and right channel video outputs for the left and right micro-displays 230.

If the display driver 220 is the Kopin A220 or A221 display driver, the Kopin CyberDisplay micro-display 230 may be CyberDisplay models 113LV, 152LV, 230LV, WQVGA LV or other compatible displays. Such display drivers 220 directly accept the 8-bit parallel BT.656 digital video signals and generates corresponding analog RGB signals for both the left and right channels.

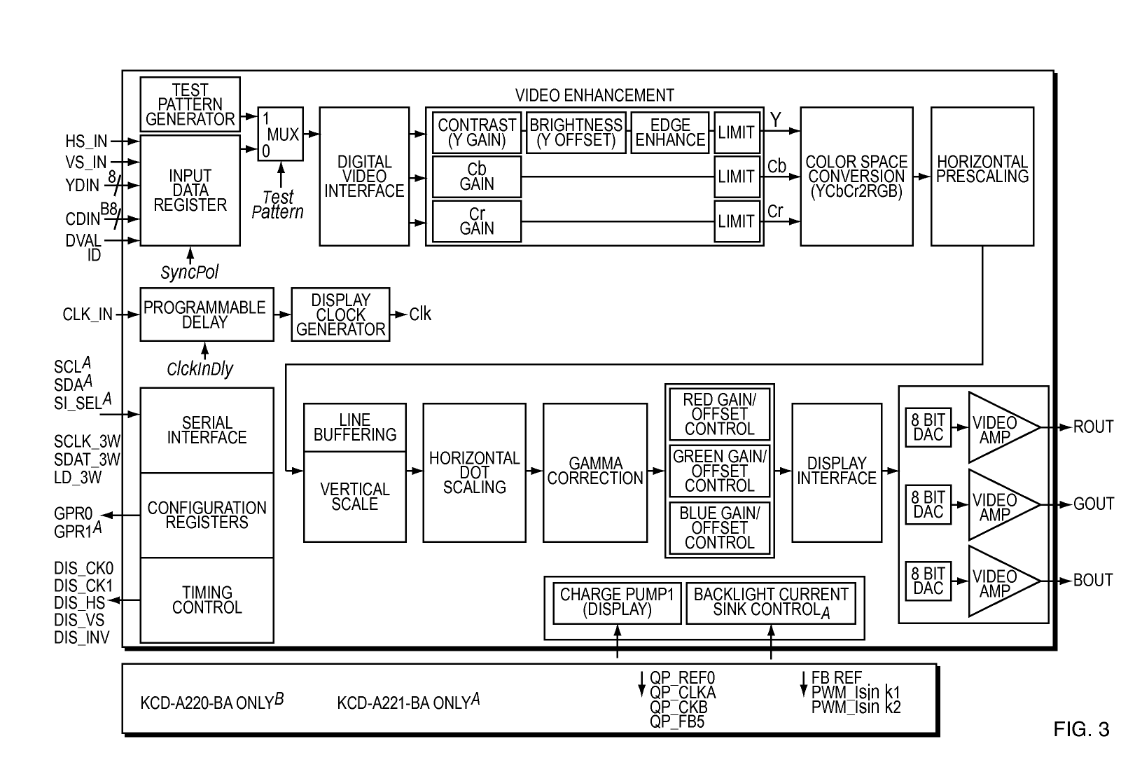

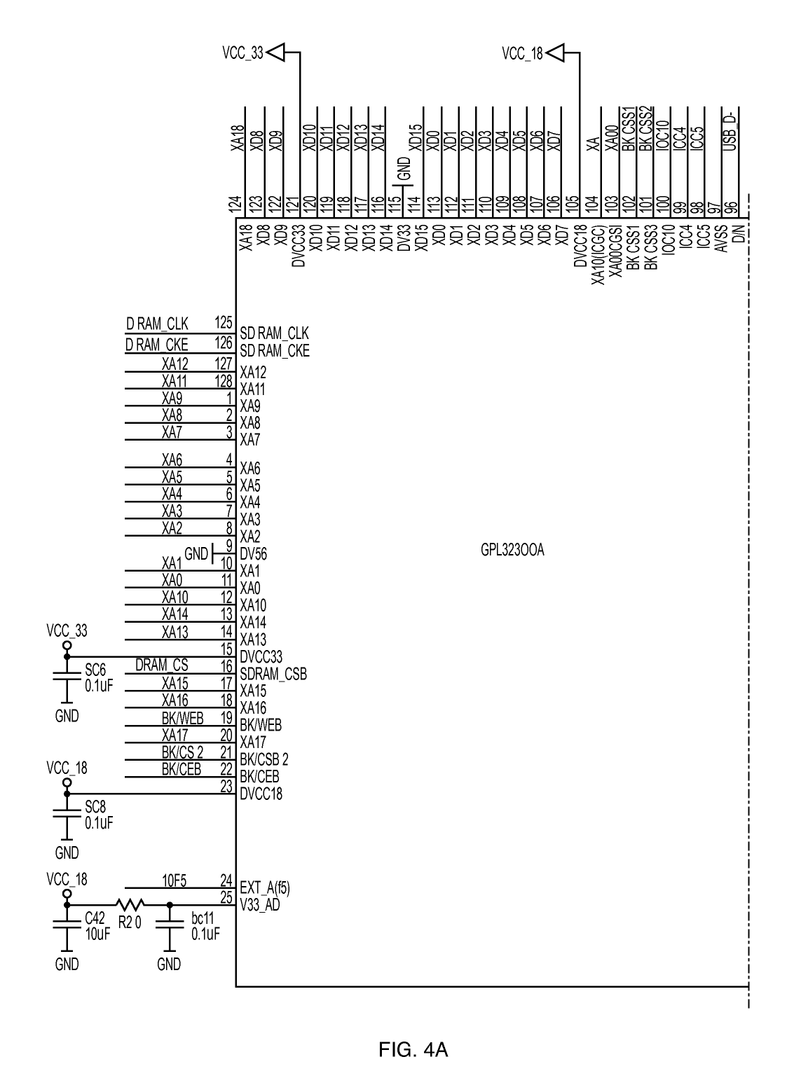

The Kopin A220 display driver 220 is shown in FIG. 3 in more detail. It includes an 8-bit digital to analog (D-to-A) converter for generating the RGB outputs required, video amplifiers and charge-pumps. It also contains color space conversion circuits to convert the YCbCr input color space into RGB outputs. It also handles horizontal and vertical scaling to accommodate different resolutions for the displays 230.

To save cost and power, there is a direct connection between the video processor 200 and the display driver 220. There is thus no video buffer or even signal conversion needed between the video processor 200 and the display driver 220.

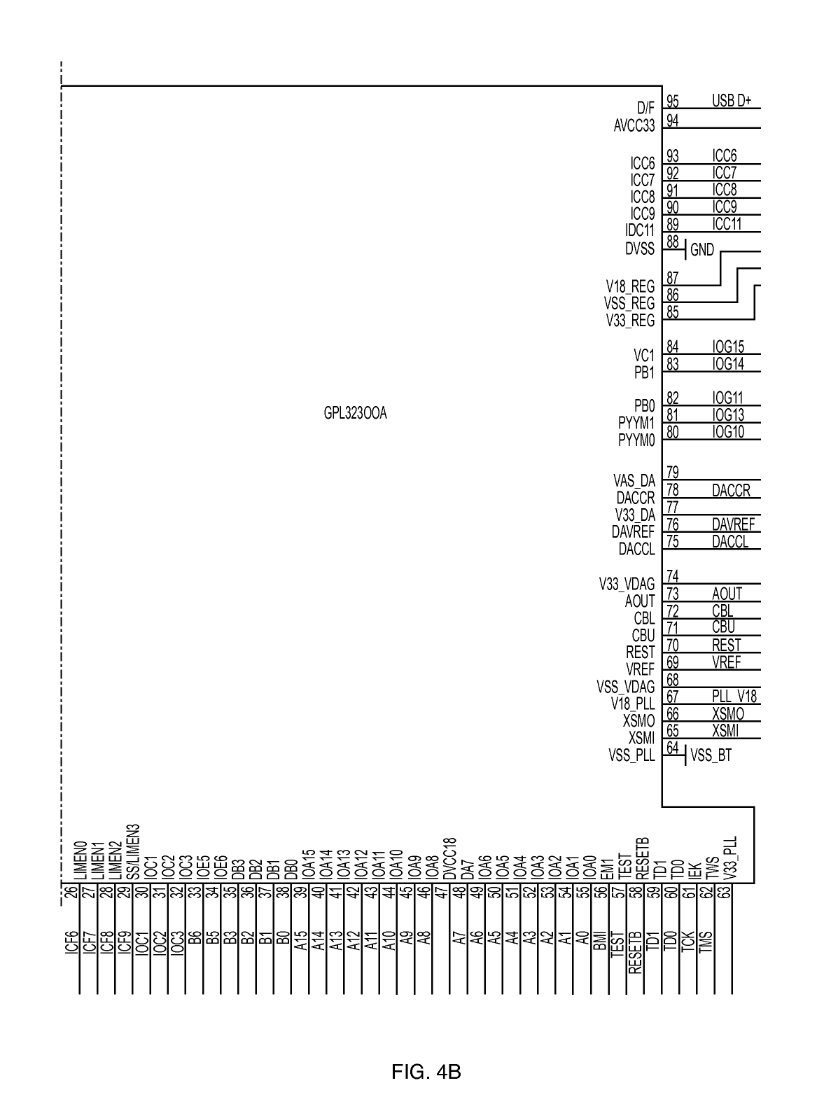

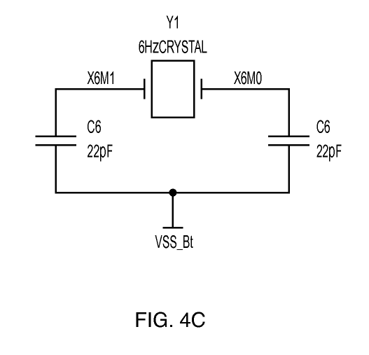

FIG. 4 shows the preferred General Plus GPL 32300A video game processor 200 in more detail. It provides dual left and right channel video signal outputs as well as horizontal sync, vertical sync and other signals to the display driver 220.

A suitable game processor chip typically contains 3-D processing hardware and firmware that can execute 3-D graphics generating software in accordance with the game program stored in the memory 240. The game processor chip 200 also interacts in accordance with user inputs provided via the joystick 250 or other user controller interface 250 to complete the game playing action. Such game processor chips may include those from Sonix (Taiwan), Elan Microelectronics (Taiwan) Nuvoton (formerly Windbond) (Taiwan) or the SSD processor used in the Xavix game console (Japan).

Because of the direct presentation of BT.656 format digital video signals from the video processor 200 to the display driver 220, much complexity has been eliminated. In particular, there is no longer any need to output and convert digital signals to analog video signals, encode or decode digital signals, provide up conversions, buffering, or other complex signal processing.

In practice it has been found that the direct parallel digital connection between the General Plus GPL 32300A 200 and Kopin display driver 220 allows increasing frame rate to the range of 43 frames per second or higher. This has been found to be just high enough to avoid perceiving flicker in a 3-D game video at a 2×320×240 resolution.

Software code processed in the video chip 200 can also provide left and right channel signals with slightly different synchronization to provide a 3-D parallax effect. In particular, when executing the software code, the 3-D processing hardware and firmware in the video chip 200 can generate a 3-D model database that has the 3-D representations of the 3-D scene with different objects at different locations. Then, a view generating portion of the software generates the left and right video channel signals by capturing the two views and rendering the images. Capturing two different views at two slightly different angles generates the two images with parallax in relation to each other which can produce a stereoscopic effect to the viewer.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus comprising:
a head-mounted display (HMD) housing;
a left micro-display located within the HMD housing, the left micro-display having a left video input port and a left display element to provide a left visual output;
a right micro-display located within the HMD housing, the right micro-display having a right video input port and a right display element to provide a right visual output;
a video processor located in the HMD housing and providing a left channel digital video signal and a right channel digital video signal; and
a display driver, also located in the HMD housing, electronically coupled directly to the video processor to receive the left and right channel digital video signals, and to output respective analog left and right channel video signals to the left and right video input ports of the respective left and right micro-displays.

2. The apparatus of claim 1 wherein the left channel digital video signal and the right channel digital video signal are provided from the video processor to the display driver over a direct digital bus interface, such that no conversion of the left or right digital video signals to analog signals is performed outside of the display driver.

3. The apparatus of claim 1 wherein the video processor and display driver are separate integrated circuits.

4. The apparatus of claim 1 wherein the video processor is a game processor.

5. The apparatus of claim 1 wherein the video processor further comprises a user input device interface.

6. The apparatus of claim 5 wherein the user input device interface is a game controller interface.

7. The apparatus of claim 1 wherein the left channel digital video signal and right channel digital video signal are rendered from a three dimensional scene model.

8. The apparatus of claim 7 wherein the left channel digital video signal and right channel digital video signal are rendered from the three dimensional scene model at two different respective viewpoints to provide parallax.

9. The apparatus of claim 1 wherein the video processor outputs frames of the left and right digital video signals alternately to drive the left and right displays through the display driver at frame rate that matches a response time of the left and right displays.

10. A method for operating a video processor integrated circuit located inside a head-mounted display (HMD) housing, the method comprising:
generating a three dimensional scene model with a video processor located inside the head-mounted display (HMD) housing;
rendering a left channel digital video signal from the three dimensional scene model;
rendering a right channel digital video signal from the three dimensional scene model;
coupling the left and right channel digital video signals directly to a display driver that is also located in the HMD housing.

11. The method of claim 10 wherein the left channel digital video signal and the right channel digital video signal are provided to the display driver over a direct digital bus interface, such that no conversion of the left or right digital video signals to analog signals is performed outside of the display driver.

12. The method of claim 10 wherein both the video processor and display driver are separate integrated circuits.

13. The method of claim 10 wherein the video processor is a game processor.

14. The method of claim 10 additionally comprising:
accepting user input commands via a user input device interface.

15. The method of claim 14 wherein the user input device interface is a game controller interface.

16. The method of claim 10 wherein the left channel digital video signal and right channel digital video signal are rendered from the three dimensional scene model at two different respective viewpoints to provide parallax.

17. The method of claim 10 wherein the left and right digital video signals are generated at a frame rate that matches a response time of a left and right microdisplay connected to the display driver.
